(19) United States
(12) Patent Application Publication
(10) Pub. No.: US 2010/0188250 A1
(43) Pub. Date: Jul. 29, 2010

(54) REMOTE CONTROLLER TRANSCEIVER

(75) Inventors: Ki Su Kim, Gyeonggi-do (KR); Young Lee, Gyeonggi-do (KR)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: SILICON COMMUNICATIONS TECHNOLOGY CO., LTD., Seoul (KR)

(21) Appl. No.: 12/676,591

(22) PCT Filed: Aug. 21, 2008
(86) PCT No.: PCT/KR2008/004872

§ 371 Date: Mar. 4, 2010

(30) Foreign Application Priority Data
Sep. 6, 2007 (KR) 10-2007-0090489

(51) Int. Cl. G05B 19/02; H04L 17/02; H04B 1/10

(52) U.S. Cl. 340/825.22; 341/176; 455/311

(57) ABSTRACT

A remote control transceiver is described. The remote control transceiver reduces costs by simplifying a structure of a conventional space movement remote controller including an acceleration sensor, a microprocessor, a radio transmitting unit, and a radio receiver. A grid pattern formed by a light emitting diode (LED) and an optical system of a transmitter is determined by an infrared sensor of a receiver to discern space movement location information of the transmitter. The remote control transceiver includes a remote control transmitter and a remote control receiver. The remote control transmitter includes a key input unit for receiving commands, an LED driver for controlling the operation of an LED in response to a command signal generated from the key input unit, and a pattern generator for generating a grid pattern using light generated from the LED. The remote control receiver detects a moving direction and a moving distance using the grid pattern received from the remote control transmitter, and generates location information corresponding to the moving direction and distance.

### PRIORITY CLAIM

The present application is a National Phase entry of PCT Application No. PCT/KR2008/004872, filed Aug. 21, 2008, which claims priority from Korean Application No. 10-2007-0090489, filed Sep. 6, 2007, the disclosures of which are hereby incorporated by reference herein in their entirety.

### FIELD OF THE INVENTION

The present invention relates to remote control transceivers, and more particularly to a remote control transceiver which can reduce production costs by eliminating radio transmitting/receiving units and simplifying a transmitting/receiving structure. That is, the present invention relates to a remote control transceiver which enables a receiver to discern location and moving direction using grid pattern information generated through an infrared light emitting diode (LED) and an optical system of a transmitter, without using a conventional complex configuration including an acceleration sensor, a microprocessor, and radio transmitting and receiving units.

The present invention also relates to a remote control transceiver which is applicable to various industrial fields using a radio transmitter and a radio receiver, especially in devices such as Internet protocol televisions (IPTVs), bidirectional cable televisions (CATVs), video-on-demand (VOD) systems, multi-function set-top boxes, and presentation systems, which are operated by movement and selection of menus.

The present invention also relates to a next-generation remote control transceiver in which a grid pattern generated from an LED and an optical system of a transmitter is projected to an infrared sensor of a receiver and the receiver interprets information about the projected grid pattern to discern movement information so that production costs are saved and thus an expensive transceiver can be replaced.

### BACKGROUND

In general, a radio transceiver (or a remote controller) for controlling a household appliance includes a keypad and an infrared LED in a transmitter and an infrared sensor and a microprocessor in a receiver. Key input information of the transmitter is converted into an infrared signal and then transmitted to the receiver. The microprocessor of the receiver processes the transmitted signal to discern information.

In IPTVs, CATVs, bidirectional CATVs, VOD systems, multi-function set-top boxes, etc. which are expected to enter into increasingly widespread use in the future, a user selects an icon type of a menu to easily control various functions of such devices and to provide convenience in selecting content. To operate the devices using a conventional remote controller, X and Y (up and down, right and left) arrow keys are inevitably used. However, as the number of menus increases, many control buttons should be provided and thus it is inconvenient for a user to operate the remote controller. To solve such a shortcoming, a space remote controller has recently appeared. If the space remote controller moves in space, a receiver detects movement of the remote controller and shifts menus like a mouse of a computer.

For example, as illustrated in FIG. 1, if a key processor of a transmitter is operated, a 3-dimensional acceleration sensor detects acceleration information according to movement. A microprocessor calculates location information and transmits the calculated location information to a radio transmitting unit. The radio transmitting unit transmits the location information to a radio receiving unit of a receiver. A microprocessor of the receiver processes received information and generates location information. The above-described structure includes the microprocessor and the radio transmitting unit in the transmitter and the microprocessor and the radio receiving unit in the receiver, thereby complicating a manufacturing process and increasing manufacturing costs.

Another example showing a space remote control function has a configuration illustrated in FIG. 2 in which if a laser beam generated from a remote controller forms an image on a screen, a camera which senses the screen receives location information of the laser beam, and a controller receives location information received through the camera and calculates location information of the laser beam. Alternatively, as shown in FIG. 3, a camera directly senses an LED light source of a remote controller and transmits the sensed signal to a controller. The controller calculates location information of light irradiated from an LED of an end of the remote controller to detect the movement of the remote controller.

However, the above examples for providing a space mouse function to the remote controller is too complicated to replace a currently used remote controller in spite of convenience, and manufacturing costs thereof are too high.

### SUMMARY

Therefore, the present invention has been made in view of the above problems, and it is an object of the present invention to provide a remote control transceiver having a space mouse function with price competitiveness by simplifying a transmitting and receiving structure.

In accordance with an aspect of the present invention, the above and other objects can be accomplished by the provision of a remote control transmitter including a key input unit for receiving commands and an LED driver for controlling the operation of an LED in response to a command signal generated from the key input unit, the remote control transmitter comprising a pattern generator for generating a grid pattern using light generated from the LED.

The pattern generator may include an XY pattern plate for generating the grid pattern by transmitting light generated from the LED, and a lens for projecting the grid pattern to a desired angle.

The XY pattern plate may have a surface on which the grid pattern is etched.

In accordance with another aspect of the present invention, there is provided a remote control receiver, comprising a pattern signal detector for detecting a moving direction of a grid pattern received from a remote control transmitter and the moving number of grids, and generating detection information using detected data, and a controller for generating location information corresponding to the detection information. The pattern signal detector may include an XY detector for detecting the moving direction of the grid pattern in the X and Y directions and the number of grids moved in the X and Y directions, and a signal processor for selecting a signal generated from the XY detector, eliminating noise included in the signal, and amplifying the noise-eliminated signal.

The XY detector may include an X-axis detector for sensing a horizontal moving direction of the grid pattern, and a Y-axis detector for sensing a vertical moving direction of the grid pattern. The signal processor may include a first filter for selecting a signal generated from the X-axis detector and eliminating noise included in the signal, a first amplifier for amplifying a signal generated from the first filter and generating the detection information, a second filter for selecting a signal generated from the Y-axis detector and eliminating noise included in the signal, and a second amplifier for amplifying a signal generated from the second filter and generating the detection information.

In accordance with still another aspect of the present invention, there is provided a remote control transceiver, comprising a remote control transmitter including a key input unit for receiving commands, an LED driver for controlling the operation of an LED in response to a command signal generated from the key input unit, and a pattern generator for generating a grid pattern using light generated from the LED, and a remote control receiver for detecting a moving direction and a moving distance using the grid pattern received from the remote control transmitter, and generating location information corresponding to the moving direction and distance.

In accordance with a further aspect of the present invention, there is provided a remote control transmitter including a key input unit for receiving commands and an LED driver for controlling the operation of an LED in response to a command signal generated from the key input unit, the remote control transmitter comprising an LED driver for generating two modulation frequencies, an LED for generating two LED lights corresponding to the two modulation frequencies, and an XY pattern plate for generating a grid pattern using the two LED lights. The XY pattern plate may include an X pattern plate for generating grid lines along one direction of the grid pattern, and a Y pattern plate for generating grid lines along the other direction of the grid pattern.

The remote control transmitter may further include a lens unit for projecting the grid pattern at a prescribed angle.

The lens unit may includes a first lens for projecting grid lines generated from the X pattern plate at a prescribed angle, and a second lens for projecting grid lines generated from the Y pattern plate at a prescribed angle.

According to the present invention, if a remote controller of a household appliance is replaced with a remote control transceiver having a space mouse function of the present invention, a user operates a remote controller in space to control the up and down, right and left movement of a menu instead of selecting the menu using arrow keys. When the remote control transceiver is applied to a projection system using a computer, a user can control the computer while giving a presentation in a meeting or lecture, without help from other people.

In addition, since manufacturing costs are reduced, the present invention is suitable for wide use of an economical remote control transceiver.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an example of the configuration of a transmitter/receiver using a conventional remote controller;

FIG. 2 is a view illustrating another example of the configuration of a transmitter/receiver using a conventional remote controller;

FIG. 3 is a view illustrating a further example of the configuration of a transmitter/receiver using a conventional remote controller;

FIG. 4 is a view illustrating the configuration of a remote control transmitter of a remote control transceiver according to the present invention;

FIG. 5 is a view illustrating the configuration of a pattern generator of a remote control transceiver according to the present invention;

FIG. 6 is a view illustrating the configuration of a remote control receiver of a remote control transceiver according to the present invention;

FIG. 7 is a view illustrating the configuration of a pattern signal detector of a remote control transceiver according to the present invention; and

FIG. 8 is a view illustrating the configuration of an LED driver, an LED, a pattern generator, and a pattern signal detector according to the present invention.

### DETAILED DESCRIPTION

Hereinafter, the exemplary embodiments of the present invention will be described with reference to the attached drawings.

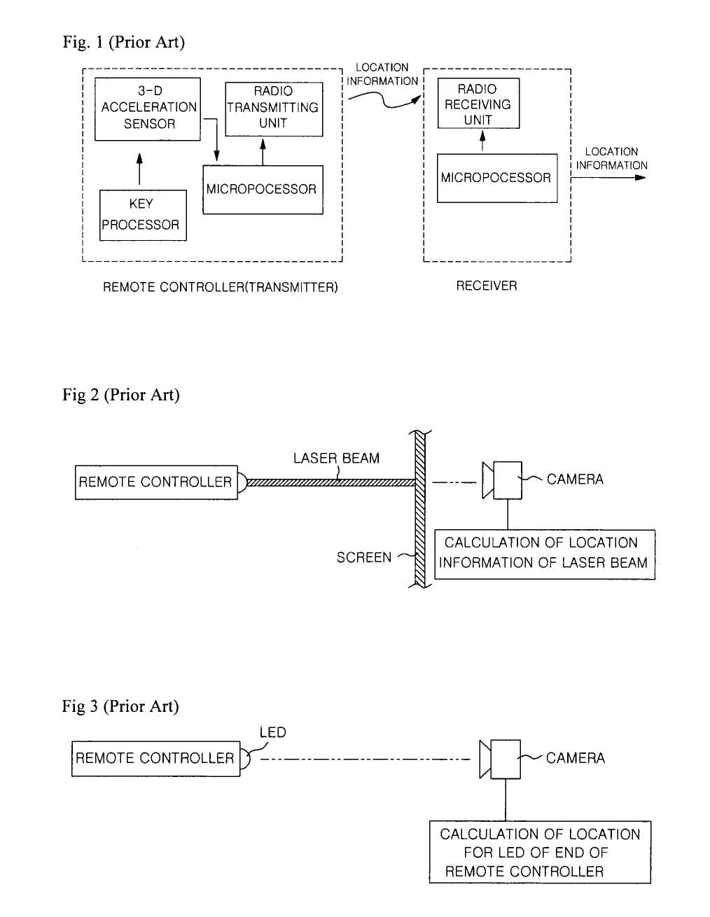

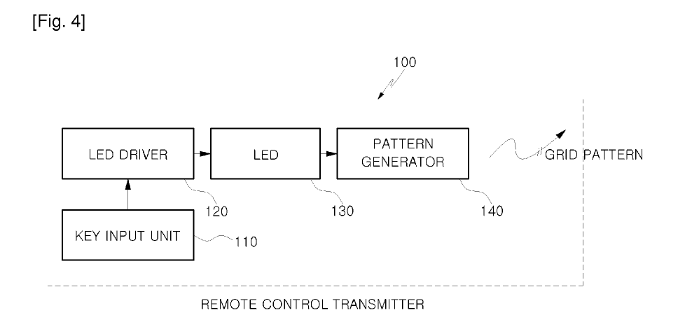

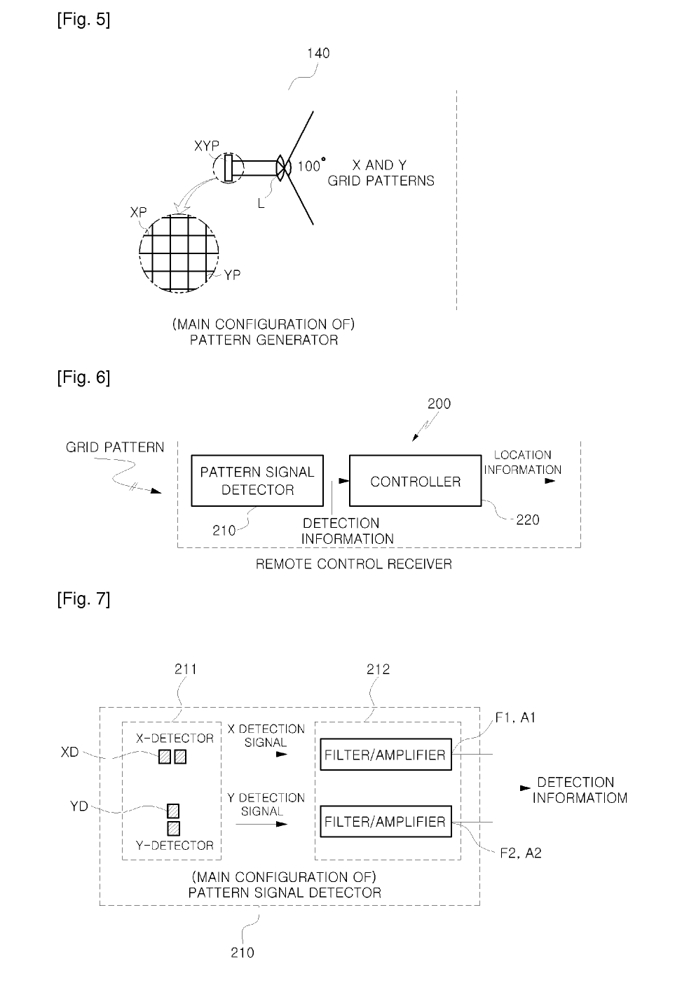

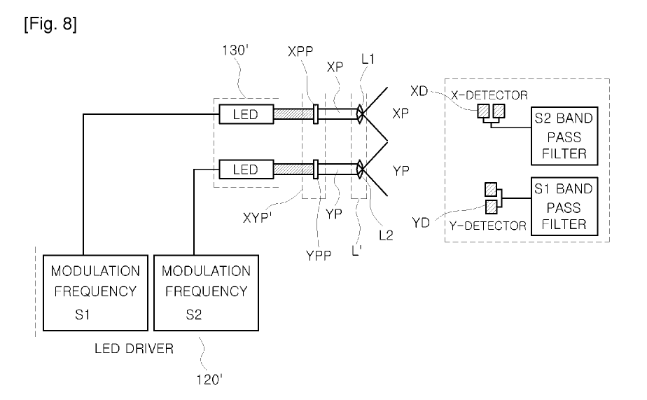

FIG. 1 is a view illustrating an example of the configuration of a transmitter/receiver using a conventional remote controller, FIG. 2 is a view illustrating another example of the configuration of a transmitter/receiver using a conventional remote controller, FIG. 3 is a view illustrating a further example of the configuration of a transmitter/receiver using a conventional remote controller, FIG. 4 is a view illustrating the configuration of a remote control transmitter of a remote control transceiver according to the present invention, FIG. 5 is a view illustrating the configuration of a pattern generator of a remote control transceiver according to the present invention, FIG. 6 is a view illustrating the configuration of a remote control receiver of a remote control transceiver according to the present invention, FIG. 7 is a view illustrating the configuration of a pattern signal detector of a remote control transceiver according to the present invention, and FIG. 8 is a view illustrating the configuration of an LED driver, an LED, a pattern generator, and a pattern signal detector according to the present invention.

Prior to a description of the present invention, a conventional technique and the present invention are compared in brief.

Conventionally, a transmitter such as a remote controller includes a 3-dimensional acceleration sensor, a microprocessor, and a radio transmitting unit. The present invention, however, has a structure which includes an LED as a light source and generates a grid pattern. That is, conventional complex and expensive constituent elements are reduced to a grid pattern generating structure to remarkably decrease manufacturing costs.

Further, a conventional receiver additionally includes a radio receiving unit which receives information from the radio transmitting unit of the transmitter. The present invention, however, provides a structure which can generate location information as well as receiving a grid pattern of the transmitter without the radio transmitting unit.

A technical configuration of the present invention will now be described.

Referring to FIG. 4, a remote control transmitter 100 includes a key input unit 110 for receiving commands, a light emitting diode (LED) driver 120 for controlling the operation of an LED 130 in response to a command signal generated from the key input unit 110, and a pattern generator 140 for generating a grid pattern using light generated from the LED 130. The LED driver 120 is driven by the switching on/off of the key input unit 110. Light generated through the LED 130 generates the grid pattern while passing through the pattern generator 140.

The pattern generator 140 includes an XY pattern plate XYP for generating the grid pattern by transmitting light generated from the LED 130, and a lens L for projecting the grid pattern at a desired angle. The XY pattern plate XYP has a surface on which the grid pattern is etched as illustrated in FIG. 5. The XY pattern plate XYP is made of glass. The XY pattern plate XYP transmits light generated from the LED 130 and the transmitted light is refracted at a prescribed angle through the lens L, thereby generating the grid pattern. FIG. 5 shows a magnified shape of the grid pattern which is etched on the XY pattern plate XYP. An X pattern XP and a Y pattern YP are etched in the horizontal (X-axis) and vertical (Y-axis) directions on the surface of the XY pattern plate XYP.

The lens L is made of a material capable of transmitting infrared wavelengths. As a refraction angle of light transmitting the lens L increases, the grid pattern can be transferred to the receiver even though a remote controller (transmitter) is not accurately directed toward a receiver, thereby providing convenience for use. However, if the refraction angle increases, since light energy should be transferred over a wide area, the output of the LED 130 should be high. Further, since the interval of the grid pattern becomes wide, accuracy is lowered when the receiver detects location. In the embodiment of the present invention, the refraction angle is set to 100 degrees and the total number of the grid patterns is set to 1000×1000, in consideration of household use. However, in products requiring accuracy such as a mouse of a computer, the refraction angle may be less than 60 degrees and the number of the grid patterns may be increased.

Meanwhile, as illustrated in FIG. 6 and FIG. 7, a remote control receiver 200 includes a pattern signal detector 210 for detecting a moving direction of the grid pattern received from the remote control transmitter and the number of grids, and generating detection information using detected data, and a controller 220 for generating location information corresponding to the detection information. The pattern signal detector 210 includes an XY detector 211 for detecting the moving direction of the grid pattern in the X and Y directions and the number of grids moved in the X and Y directions, and a signal processor 212 for selecting a signal generated from the XY detector 211, eliminating noise included in the signal, and amplifying the noise-eliminated signal.

As illustrated in FIG. 7, the XY detector 211 includes an X-axis detector XD having two sensors which are horizontally arranged to sense a horizontal moving direction of the grid pattern, and a Y-axis detector YD having two sensors which are vertically arranged to sense a vertical moving direction of the grid pattern. If the grid pattern is received from the remote control transmitter, the X-axis and Y-axis detectors XD and YD of the XY detector 211 sense the movement of the grid pattern. That is, if the right and left movement of the remote control transmitter occurs, the Y pattern YP of a vertical direction passes through the X-axis detector XD. The receiver detects a moving direction of the Y pattern YP and the number of movements of the Y pattern YP according to which of the two horizontally arranged sensors is first sensed. The controller 200 processes the detection information to confirm the right and left movement locations of the remote control transmitter. Similarly, if the up and down movement of the remote control transmitter occurs, the X pattern XP of a horizontal direction passes through the Y-axis detector YD. The receiver detects a moving direction of the X pattern XP and the number of movements of the X pattern XP according to which of the two vertically arranged sensors is first sensed. The controller 200 processes the detection information to confirm the up and down movement locations of the remote control transmitter.

The signal processor 212 includes, as illustrated in FIG. 7, a first filter F1 for selecting a signal generated from the X-axis detector XD and eliminating noise included in the signal, a first amplifier A1 for amplifying a signal generated from the first filter F1 and generating the detection information, a second filter F2 for selecting a signal generated from the Y-axis detector YD and eliminating noise included in the signal, and a second amplifier A2 for amplifying a signal generated from the second filter F2 and generating the detection information

Meanwhile, in a remote control transmitter including the key input unit 110 for receiving commands and the LED driver 120 for controlling the operation of the LED 130 in response to a command signal generated from the key input unit 110, the remote control transmitter includes an LED driver 120′ for generating two modulation frequencies, an LED 130′ for generating two LED lights corresponding to the two modulation frequencies, and an XY pattern plate XYP′ for generating a grid pattern using the two LED lights as illustrated in FIG. 8. The XY pattern plate XYP′ includes an X pattern plate XPP for generating grid lines along one direction of the grid pattern, and a Y pattern plate YPP for generating grid lines along the other direction of the grid pattern. The remote control transmitter further includes a lens unit L′ for projecting the grid pattern at a prescribed angle. The lens unit L′ includes a first lens L1 for projecting grid lines generated from the X pattern plate XPP at a prescribed angle, and a second lens L2 for projecting grid lines generated from the Y pattern plate YPP at a prescribed angle.

FIG. 8 shows a configuration to improve accuracy by preventing a location information calculation error due to mutual interference of the X and Y patterns XP and YP. When a grid pattern is sensed, the X pattern XP should be detected by the Y-axis detector YD and the Y pattern YP should be detected by the X-axis detector XD to accurately detect a moving direction of the grid pattern and the number of movements of the grid pattern. However, if the X pattern XP is detected by the X-axis detector XD or the Y pattern YP is detected by the Y-axis detector YD, a detection error may occur. Accordingly, as illustrated in FIG. 8, the LED 130′ having two independent LEDs which modulated respectively to different modulation frequencies S1 and S2, the XY pattern plate XYP′ having two independent pattern plates XPP and YPP, and lenses L1 and L2 are used. The XY pattern plate XYP′ generates the X pattern XP and the Y pattern YP using the X pattern plate XPP and the Y pattern plate YPP, respectively, instead of the grid pattern in which the X and Y patterns are overlapped. The generated patterns XP and YP are projected through the lens unit L′ at a prescribed angle. In the receiver, a band pass filter for passing through only a frequency of an S2 band is connected to an output terminal of the X-axis detector XD, and a band pass filter for passing through only a frequency of an S1 band is connected to an output terminal of the Y-axis detector YD.

That is, since the X pattern XP and the Y pattern YP are LED lights modulated respectively to the different frequencies S1 and S2, the X pattern XP can be sensed only by the Y-axis detector YD and the Y pattern YP can be sensed only by the X-axis detector XD. Accordingly, a reduction in detection accuracy due to mutual interference of the X pattern XP and the Y pattern YP can be prevented.

One exemplary embodiment of the present invention of the remote control transceiver according to the present invention will now be described with reference to FIG. 4 to FIG. 7.

1) The key input unit 110 is switched on.

2) The LED driver 120 is driven and light generated from the LED 130 passes through the pattern generator 140 (at this time, a refraction angle is set to 100 degrees).

3) An LED light passing through the pattern generator 140 is generated as a grid pattern.

4) The generated grid pattern is transferred to the pattern signal detector 210.

5) The XT detector 211 detects the movement of the grid pattern in the process of 4).

6) A signal detected in the process of 5) is transmitted to the controller 220 via the signal processor 212.

7) The controller 220 generates location information.

Another exemplary embodiment of the remote control transceiver according to the present invention will now be described with reference to FIG. 8.

1) The LED driver 120′ is driven.

2) The modulation frequencies S1 and S2 of 35 KHz and 45 KHz are generated in the process of 1).

3) Two LED lights are generated by driving the two LEDs of the LED 130′ using the two different modulation frequencies S1 and S2 in the process of 2).

4) One of the two LED lights passes through the X pattern plate XPP and the other one passes through the Y pattern plate YPP, thereby generating the X pattern XP and the Y pattern YP.

5) Lights (X pattern and Y pattern) generated in the process of 4) are respectively projected through the first lens L1 and the second lens L2 (at this time, refraction angles of the first and second lenses L1 and L2 are 100 degrees).

6) The X pattern XP and the Y pattern YP generated in the process of 5) are detected by the Y-axis detector YD and the X-axis detector XD, respectively, and transmitted to the controller 220 via the band pass filters (the structure of the controller is as in one exemplary embodiment of the present invention).

7) The Y pattern YP detected by the X-axis detector XD passes through the band pass filter having a frequency band of 41 to 50 KHz and the X pattern XP detected by the Y-axis detector YD passes through the band pass filter having a frequency band of 30 to 40 KHz.

8) Information generated in the process of 7) is processed by the controller 220 to generate location information.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

1. A remote control transmitter including a key input unit for receiving commands and a light emitting diode (LED) driver for controlling the operation of an LED in response to a command signal generated from the key input unit, the remote control transmitter comprising:
a pattern generator for generating a grid pattern using light generated from the LED 130.

2. The remote control transmitter according to claim 1, wherein the pattern generator includes:
an XY pattern plate for generating the grid pattern by transmitting light generated from the LED; and
a lens for projecting the grid pattern to a desired angle

3. The remote control transmitter according to claim 2, wherein the XY pattern plate has a surface on which the grid pattern is etched.

4. A remote control receiver, comprising:
a pattern signal detector for detecting a moving direction of a grid pattern received from a remote control transmitter and the moving number of grids, and generating detection information using detected data; and
a controller for generating location information corresponding to the detection information.

5. The remote control receiver according to claim 4, wherein the pattern signal detector includes:
an XY detector for detecting the moving direction of the grid pattern in the X and Y directions and the number of grids moved in the X and Y directions; and
a signal processor for selecting a signal generated from the XY detector, eliminating noise included in the signal, and amplifying the noise-eliminated signal.

6. The remote control receiver according to claim 5, wherein the XY detector includes:
an X-axis detector for sensing a horizontal moving direction of the grid pattern; and
a Y-axis detector for sensing a vertical moving direction of the grid pattern.

7. The remote control receiver according to claim 5, wherein the signal processor includes:
a first filter for selecting a signal generated from the X-axis detector and eliminating noise included in the signal;
a first amplifier for amplifying a signal generated from the first filter and generating the detection information;
a second filter for selecting a signal generated from the Y-axis detector and eliminating noise included in the signal; and
a second amplifier for amplifying a signal generated from the second filter and generating the detection information.

8. A remote control transceiver, comprising:
a remote control transmitter including a key input unit for receiving commands, a light emitting diode (LED) driver for controlling the operation of an LED in response to a command signal generated from the key input unit, and a pattern generator for generating a grid pattern using light generated from the LED; and
a remote control receiver for detecting a moving direction and a moving distance using the grid pattern received from the remote control transmitter, and generating location information corresponding to the moving direction and distance.

9. A remote control transmitter including a key input unit for receiving commands and a light emitting diode (LED) driver for controlling the operation of an LED in response to a command signal generated from the key input unit, the remote control transmitter comprising:
an LED driver for generating two modulation frequencies;
an LED for generating two LED lights corresponding to the two modulation frequencies; and
an XY pattern plate for generating a grid pattern using the two LED lights.

10. The remote control transmitter according to claim 9, wherein the XY pattern plate includes:
an X pattern plate for generating grid lines along one direction of the grid pattern; and
a Y pattern plate for generating grid lines along the other direction of the grid pattern.

11. The remote control transmitter according to claim 9, further includes a lens unit for projecting the grid pattern at a prescribed angle.

12. The remote control transmitter according to claim 11, wherein the lens unit includes:
a first lens for projecting grid lines generated from the X pattern plate at a prescribed angle; and
a second lens for projecting grid lines generated from the Y pattern plate at a prescribed angle.
